(19) United States
(12) Patent Application Publication
(10) Pub. No.: US 2017/0337232 A1
(43) Pub. Date: Nov. 23, 2017

(54) METHODS OF STORING AND QUERYING DATA, AND SYSTEMS THEREOF

(71) Applicant: FIFTH DIMENSION HOLDINGS LTD., TEL AVIV (IL)

(72) Inventors: Guy CASPI, Tel Aviv (IL); Doron COHEN, Karkur (IL); Yoel NEEMAN, Ra'anana (IL); Eli DAVID, Holon (IL); Ariel ZAMIR, Tel Aviv (IL)

(21) Appl. No.: 15/158,786

(22) Filed: May 19, 2016

(51) Int. Cl. G06F 17/30

(52) U.S. Cl. CPC G06F 17/30345; G06F 17/30569; G06F 17/30067; G06F 17/30477; G06F 17/30554

(57) ABSTRACT

According to some embodiments, there is provided a method of querying data in a data structure comprising a plurality of databases, at least a first database of the plurality of databases having a different structure than a second database of the plurality of databases. This method can involve the construction of one or more sub-queries and the use of at least a routing table for directing the sub-queries towards the database. According to some embodiments, the routing table is dynamic. According to some embodiments, there is provided a method of inserting data into the data structure, the method comprising updating the routing table based on the insertion of data. Various other methods and systems of querying and inserting data are described.

### TECHNICAL FIELD

The presently disclosed subject matter relates to the field of storing and querying data.

### BACKGROUND

In various fields, it is necessary to store data in a database and to perform queries on these data.

Depending on the field, the amount of the data to be stored can be large. In addition, the data can be of various types and formats, and can be provided by different sources. Thus, the querying of this data becomes more difficult.

For example, in the insurance field, it is necessary to store large amounts of data on customers, on their claims, etc. Many other technical fields face similar requirements.

There is a need to propose new methods and systems for storing and querying data.

### GENERAL DESCRIPTION

In accordance with certain aspects of the presently disclosed subject matter, there is provided a method of querying data in a data structure comprising a plurality of databases, at least a first database of the plurality of databases having a different structure than a second database of the plurality of databases, the method comprising, by at least a processing unit, providing at least a routing table associating to each keyword of a list of keywords at least one database of the data structure; for a data query, constructing at least a sub-query based on the data query, determining, based on at least said routing table, at least a keyword present in the sub-query and at least one database of the data structure associated to said at least keyword, sending said sub-query to said at least one database which is associated to the keyword present in said sub-query in the routing table, extracting data from said at least one database based on said sub-query, and outputting a result to the data query based at least on the extracted data.

According to some embodiments, the method comprises constructing a first sub-query based on the data query, sending the first sub-query to at least a database of the data structure which is associated in the routing table to a first keyword present in the first sub-query, constructing a second sub-query based on the data query, sending the second sub-query to at least a database of the data structure which is associated in the routing table to a second keyword present in the second sub-query, and outputting a result to the data query based at least on the results of the first and second sub-queries. According to some embodiments, the method comprises constructing a first sub-query based on the data query, sending the first sub-query to at least a database of the data structure which is associated in the routing table to a first keyword of the first sub-query, for providing first results, constructing a second sub-query based on the data query and on the first results, sending the second sub-query to at least a database of the data structure which is associated in the routing table to a second keyword present in the second sub-query, and outputting a result to the data query based at least on the results of the second sub-query. According to some embodiments, the method comprises constructing a first sub-query based on the data query and a second sub-query based on the data query, wherein if a first keyword of the first sub-query and a second keyword of the second sub-query are associated to the same database in the routing table, the method comprises merging the first sub-query and the second sub-query into a consolidated sub-query. According to some embodiments, the plurality of databases comprises at least one of a key value store database, a search engine database, and a graph database. According to some embodiments, the data structure further comprises a file system. According to some embodiments, the method comprises aggregating the data extracted from each database, to output the result to the data query based on said aggregation. According to some embodiments, the sub-query is expressed in a programming language which is independent from a programming language understandable by each database. According to some embodiments, an adapter converts at least part of the sub-query in a programming language which is understandable by each database to which the sub-query is sent. According to some embodiments, the method comprises updating the routing table when new data are inserted in the data structure, said update comprising associating at least a keyword present in the new data to at least a database of the data structure. According to some embodiments, the method comprises updating the routing table when a new database is inserted into the data structure, said update comprising associating at least a keyword to said new database in the routing table. According to some embodiments, when a new database is inserted into the data structure, the method comprises using an adapter which converts the sub-query which is to be sent to said new database in a programming language which is understandable by said new database. According to some embodiments, a querying layer of the system which computes each sub-query to be sent to each database based on the data query remains unchanged when a new database is inserted in the data structure. According to some embodiments, when data are inserted into at least a database of the data structure, the method comprises extracting at least a keyword from said data, and associating in the routing table said keyword to the database in which said data were inserted. According to some embodiments, the method comprises updating the association of the keywords with the database in the routing table during time. According to some embodiments, the method comprises measuring a time response for a plurality of previous data queries, and updating the routing table and/or selecting the database to which a current sub-query is sent based at least on said time response. According to some embodiments, the method comprises measuring a first time response for at least a previous sub-query comprising at least a first keyword and a second time response for at least a previous sub-query comprising at least a second keyword, constructing at least a first sub-query and a second sub-query based on the data query, wherein the first sub-query comprises said first keyword and the second sub-query comprises said second keyword, wherein the order in which the first sub-query and the second sub-query are executed is based on a comparison between the first time response and the second time response. According to some embodiments, the method comprises, for at least a keyword associated to a plurality of databases in the routing table, sending a sub-query to each database, measuring performances of each sub-query and associating one of the databases to said keyword in the routing table based on a comparison between the performances of each sub-query. According to some embodiments, the method comprises, updating the routing table and/or selecting the database to which a current sub-query is sent based at least on current and/or past load of the databases, size of a current data query, time response measured for previous data queries, type of the current data query, current resources of the processing unit. These embodiments can be combined according to any of their possible technical combination.

In accordance with some aspects of the presently disclosed subject matter, there is provided a method of inserting data in a data structure comprising a plurality of databases, at least a first database of the plurality of databases having a different structure than a second database of the plurality of databases, the method comprising, by at least a processing unit, selecting a subset of data to be inserted in each database, based on at least an insertion criterion, inserting each subset of data in each database, extracting keywords from the data of each subset of data, updating a routing table, said update comprising associating in said routing table the keywords extracted from each subset of data to the database in which said subset of data was inserted, said routing table being used at least for querying the data in the data structure.

According to some embodiments, the method comprises updating the routing table when a new database is inserted in the data structure. According to some embodiments, the method comprises comprising updating the routing table when new data are inserted in the data structure. According to some embodiments, the method comprises inserting data that are expected to be directly queried by a user in a database of the data structure which is queriable by a plurality of keys, and/or inserting data that are not expected to be directly queried by the user in a database of the data structure which is queriable only by a single key.

These embodiments can be combined according to any of their possible technical combination.

In accordance with some aspects of the presently disclosed subject matter, there is provided a non-transitory storage device readable by a processing unit, tangibly embodying a program of instructions executable by a processing unit to perform a method of querying data in a data structure comprising a plurality of databases, at least a first database of the plurality of databases having a different structure than a second database of the plurality of databases, the method comprising providing a routing table associating to each keyword of a list of keywords at least one database of the data structure; for a data query constructing at least a sub-query based on the data query, determining, based on at least said routing table, at least a keyword present in the sub-query and at least one database of the data structure associated to said at least keyword, sending said sub-query to said at least one database which is associated to the keyword present in said sub-query in the routing table, extracting data from said at least one database based on said sub-query, and outputting a result to the data query based at least on the extracted data.

In accordance with some aspects of the presently disclosed subject matter, there is provided a system comprising a data structure comprising a plurality of databases, at least a first database of the plurality of databases having a different structure than a second database of the plurality of databases, at least a routing table associating to each keyword of a list of keywords at least one database of the data structure, and at least a processing unit configured to, for a data query, construct at least a sub-query based on the data query, determine, based on at least said routing table, at least a keyword present in the sub-query and at least one database of the data structure associated to said at least keyword, send said sub-query to said at least one database which is associated to the keyword present in said sub-query in the routing table, extract data from said at least one database based on said sub-query, and output a result to the data query based at least on the extracted data. According to some embodiments, the processing unit is configured to construct a first sub-query based on the data query, send the first sub-query to at least a database of the data structure which is associated in the routing table to a first keyword present in the first sub-query, construct a second sub-query based on the data query, send the second sub-query to at least a database of the data structure which is associated in the routing table to a second keyword present in the second sub-query, and output a result to the data query based at least on the results of the first and second sub-queries. According to some embodiments, the processing unit is configured to construct a first sub-query based on the data query, send the first sub-query to at least a database of the data structure which is associated in the routing table to a first keyword of the first sub-query, for providing first results, construct a second sub-query based on the data query and on the first results, send the second sub-query to at least a database of the data structure which is associated in the routing table to a second keyword present in the second sub-query, and output a result to the data query based at least on the results of the second sub-query. According to some embodiments, the processing unit is configured to construct a first sub-query based on the data query and a second sub-query based on the data query, wherein if a first keyword of the first sub-query and a second keyword of the second sub-query are associated to the same database in the routing table, the processing unit is configured to merge the first sub-query and the second sub-query into a consolidated sub-query. According to some embodiments, the plurality of databases comprises at least one of a key value store database, a search engine database, and a graph database. According to some embodiments, the data structure further comprises a file system. According to some embodiments, the processing unit is configured to aggregate the data extracted from each database, to output the result to the data query based on said aggregation. According to some embodiments, the processing unit is configured to express the sub-query in a programming language which is independent from a programming language understandable by each database. According to some embodiments, the system further comprises an adapter which is configured to convert at least part of the sub-query in a programming language which is understandable by each database to which the sub-query is sent. According to some embodiments, the processing unit is configured to update the routing table when new data are inserted in the data structure, said update comprising associating at least a keyword present in the new data to at least a database of the data structure. According to some embodiments, the processing unit is configured to update the routing table when a new database is inserted into the data structure, said update comprising associating at least a keyword to said new database in the routing table. According to some embodiments, when a new database is inserted into the data structure, the system is configured to receive an adapter which converts the sub-query which is to be sent to said new database in a programming language which is understandable by said new database. According to some embodiments, a querying layer of the data structure which computes each sub-query to be sent to each database based on the data query remains unchanged when a new database is inserted in the data structure. According to some embodiments, when data are inserted into at least a database of the data structure, the processing unit is configured to extract at least a keyword from said data, and associate in the routing table said keyword to the database in which said data were inserted. According to some embodiments, the processing unit is configured to update the association of the keywords with the database in the routing table over time. According to some embodiments, the processing unit is configured to measure a time response for a plurality of previous data queries, and update the routing table and/or select the database to which a current sub-query is sent based at least on said time response. According to some embodiments, the processing unit is configured to measure a first time response for at least a previous sub-query comprising at least a first keyword and a second time response for at least a previous sub-query comprising at least a second keyword, and construct at least a first sub-query and a second sub-query based on the data query, wherein the first sub-query comprises said first keyword and the second sub-query comprises said second keyword, wherein the order in which the first sub-query and the second sub-query are executed is based on a comparison between the first time response and the second time response. According to some embodiments, for at least a keyword associated to a plurality of databases in the routing table, the processing unit is configured to send a sub-query to each database, measure performance of each sub-query, and associate one of the databases to said keyword in the routing table based on a comparison between performance of each sub-query. According to some embodiments, the processing unit is configured to update the routing table and/or select the database to which a current sub-query is sent based at least on current and/or past load of the databases, size of a current data query, time response measured for previous data queries, type of the current data query, and current resources of the processing unit.

These embodiments can be combined according to any of their possible technical combination.

In accordance with some aspects of the presently disclosed subject matter, there is provided a system for inserting data in a data structure comprising a plurality of databases, at least a first database of the plurality of databases having a different structure than a second database of the plurality of databases, the system comprising at least a processing unit configured to select a subset of data to be inserted in each database, based on at least an insertion criterion, insert each subset of data in each database, extract keywords from the data of each subset of data, and update a routing table of the data structure, said update comprising associating in said routing table the keywords extracted from each subset of data to the database in which said subset of data was inserted, said routing table being used at least for querying the data in the data structure.

According to some embodiments, the processing unit is configured to update the routing table when a new database is inserted in the data structure. According to some embodiments, the processing unit is configured to update the routing table when new data are inserted in the data structure. According to some embodiments, the processing unit is configured to insert data that are expected to be directly queried by a user in a database of the data structure which is queriable by a plurality of keys, and/or insert data that are not expected to be directly queried by the user in a database of the data structure which is queriable only by a single key.

These embodiments can be combined according to any of their possible technical combination.

In accordance with some aspects of the presently disclosed subject matter, there is provided a non-transitory storage device readable by a processing unit, tangibly embodying a program of instructions executable by a processing unit to perform a method of inserting data in a data structure comprising a plurality of databases, at least a first database of the plurality of databases having a different structure than a second database of the plurality of databases, the method comprising selecting a subset of data to be inserted in each database, based on at least an insertion criterion, inserting each subset of data in each database, extracting keywords from the data of each subset of data, and updating a routing table, said update comprising associating in said routing table the keywords extracted from each subset of data to the database in which said subset of data was inserted, said routing table being used at least for querying the data in the data structure.

According to some embodiments, the solution proposes a system which comprises a plurality of databases, and which takes advantage of the assets of each database for storing data and/or performing data queries.

According to some embodiments, the solution proposes a system which is scalable.

According to some embodiments, the solution proposes a system which can absorb new data and/or a new database in an efficient way.

According to some embodiments, the solution proposes a system which can absorb new data and/or a new database in a simple way, without needing to make important changes to the architecture. In particular, at least a part of the system is, according to some embodiments, insensitive to the addition of a new database.

According to some embodiments, the solution proposes a system which optimizes the performances of the data query, based on various parameters.

According to some embodiments, the solution proposes a system which allows a user to query a large variety of data.

According to some embodiments, the solution proposes a system which allows the storing and querying of a large volume of data.

According to some embodiments, the solution proposes a system which allows storing and querying data with different formats, and/or coming from different sources.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an embodiment of a system according to the invention, said system comprising a data structure;

FIG. 2 is a representation of an embodiment of a database which can be used in the data structure;

FIG. 3 is a representation of another embodiment of a database which can be used in the data structure;

FIG. 4 is a representation of another embodiment of a database which can be used in the data structure;

FIG. 5 is a representation of an embodiment of a data store which can be used in the data structure;

FIG. 6 is a representation of an embodiment of a method of inserting data in the data structure;

FIG. 7 is a representation of an embodiment of a routing table;

FIG. 8 illustrates an embodiment of a method of building a routing table;

FIG. 8A illustrates an embodiment of a method of updating a routing table;

FIG. 9 illustrates an embodiment of method of querying data into the data structure;

FIG. 10 illustrates an embodiment of a method of querying data into the data structure, wherein the data query is split into at least two sub-queries;

FIG. 11 illustrates an embodiment in which a first sub-query and a second sub-query are merged;

FIG. 12 illustrates an embodiment of an adapter for converting the sub-query into the programming language of each database;

FIG. 13 illustrates an embodiment of parts of an adapter;

FIG. 14 illustrates an embodiment in which a new database is inserted into the data structure;

FIG. 15 illustrates an update of the adapter in the embodiment of FIG. 14;

FIG. 16 illustrates an embodiment of updating/optimizing the routing table;

FIG. 17 illustrates an embodiment of an optimization vector;

FIGS. 18A to 18C illustrate a simplified and non limiting example in which a data query is performed.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “determining”, “extracting”, “sending”, “outputting”, “aggregating”, “expressing”, “optimizing”, “updating”, “inserting”, “associating”, or the like, refer to the action(s) and/or process(es) of a processing unit that manipulate and/or transform data into other data, said data represented as physical, such as electronic, quantities and/or said data representing the physical objects.

The term “processing unit” covers any computing unit or electronic unit that can perform tasks based on instructions stored in a memory, such as a computer, a server, a chip, etc. It encompasses a single processor or multiple processors, which may be located in the same geographical zone or may, at least partially, be located in different zones and may be able to communicate together.

The term “non-transitory memory” used herein should be expansively construed to cover any volatile or non-volatile computer memory suitable to the presently disclosed subject matter.

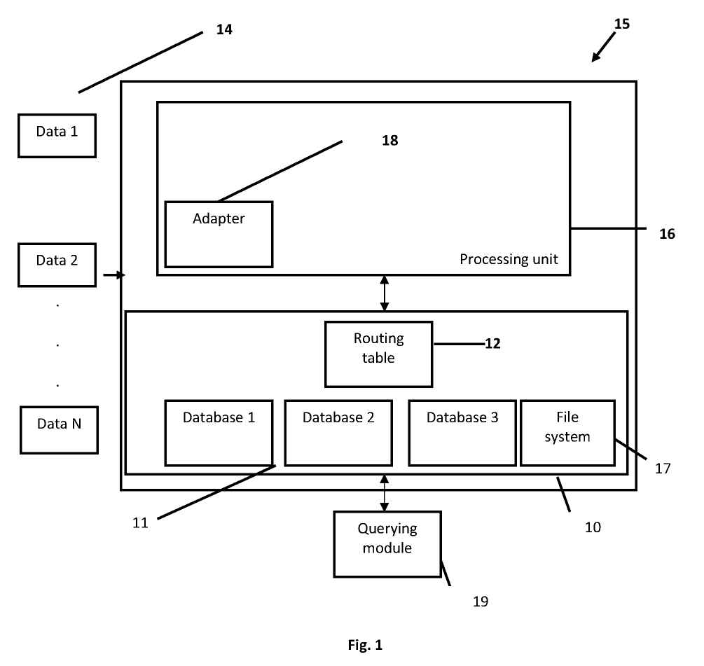

FIG. 1 represents an embodiment of a system 15 which allows at least e.g. storing and/or querying storing data. This functional representation is a non limiting representation.

As shown, the system 15 can comprise a data structure 10 for storing data. The data structure 10 can comprise a plurality of databases 11. In this data structure 10, at least a first database of the plurality of databases has a different structure than a second database of the plurality of databases. The expression “structure” of a database includes the way the data are organized and/or stored and/or queriable in the database. According to some embodiments, the plurality of databases includes at least one of a key value store database, a search engine database, and a graph database. This list is not limitative and various other structures of database can be used. For example, a PostgreSQL database can be used.

The different databases can be operable on the same or on various computer(s)/processing unit(s), depending on the applications.

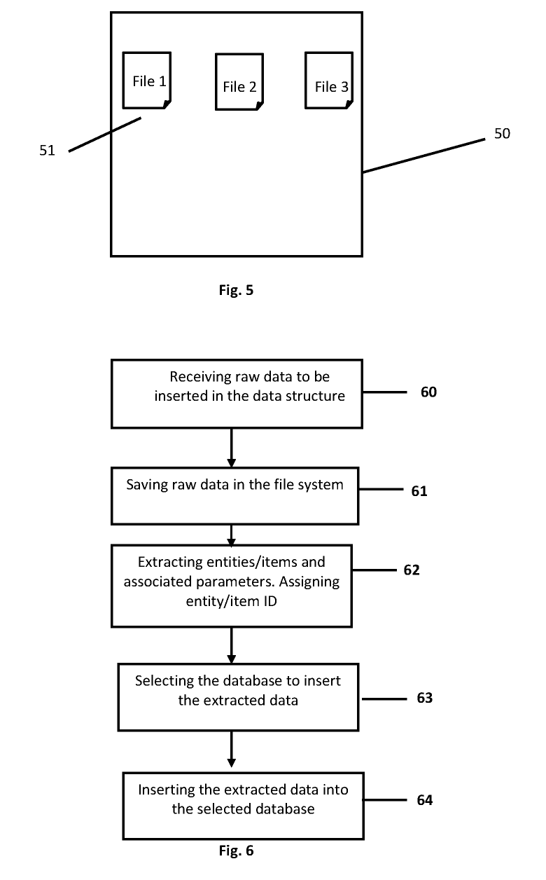

The data structure 10 can further comprise a data store 17, also called file system, which will be described further with respect to FIG. 5.

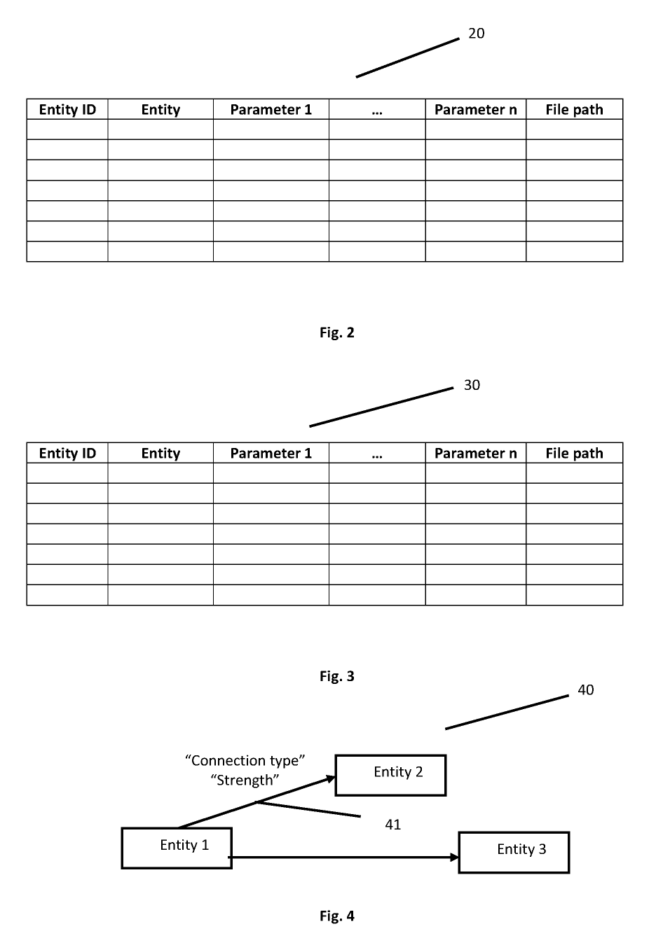

Examples of different structures of database will be provided in relation to FIGS. 2 to 4.

The system 15 can also comprise at least a processing unit 16 which can perform various tasks which will be described later in the specification, such as (but not limited to) querying data and/or inserting data (such as data 14) in the data structure 10. Although the processing unit 16 was depicted in FIG. 1 outside the data structure 10, it is to be noted that according to some embodiments the processing unit 16 can also be part of the data structure 10.

In addition, the different parts of the system can be distributed differently from the representation of FIG. 1, which is not limitative.

The system 15 can also comprise a querying module 19, or communicate with a querying module 19. According to some embodiments, the querying module 19 can send data queries to the system 15. The querying module 19 can be operable on a processing unit.

According to some embodiments, the querying module 19 can communicate with the system 15 using for example (but not limited to) a command-line interface (CLI), a wire-protocol, a network, AJAX, an API (such as a RESTful API), etc. A user or a programmer can thus send data queries using this querying module.

According to some embodiments, the querying module 19 can comprise a user interface which allows a user to interact with the system 15, for example to send data queries.

According to some embodiments, the querying module 19 includes a user interface with a visual representation which can be displayed on a screen (such as a screen of a computer), for allowing a user to interact with the system 15. This type of user interface is a non limitative example. This interaction can for example allow the user to formulate a data query, and/or to view the results of the data query, etc.

According to some embodiments, the querying module can allow the user to modify parameters of the system 15.

FIG. 2 is simplified representation of an embodiment of a database 20 which can be used in the data structure (it can correspond to one of the databases 11 of FIG. 1).

This database is called a key value store database.

FIG. 2 is a representation of the way the data can be stored. Other configurations can be used. The database can include various columns Although the representation of FIG. 2 is in the form of a table comprising lines and columns, it is to be understood that in practice the data can be stored using different structures. The representation in the form of a table is used as a possible example only.

As shown in FIG. 2, a column of the database 20 can correspond to an “entity”. The entity generally designates a category of the data and can depend on the technical field of the data. For example, if the data are data of an insurance company, the entity can correspond to a relevant category in this technical field, such as “customer”, “insurance policy”, “bank account”, etc.

According to some embodiments, the database can include for some data a column called “Item” which can designate the nature of the data. The items generally depend on the technical field of the data.

For example, if data are data stored by the police on criminality, examples of items can include e.g. “image”, “voice”, “phone call”, etc.

The division of data into “entities” and “items” is not limitative and other representations of the data can be used.

As depicted in FIG. 2, the database 20 can comprise a column corresponding to the “Entity ID”. The Entity ID can be a unique value (such as a number and/or strings(s)) in the database for designating an entity. If the database comprises items, then the database can comprise an “Item ID”.

The database 20 can further comprise for each entity (or each item) different parameters (parameters 1 to n) which include data associated to each entity. In some examples, these parameters are also called “metadata”.

For example, if the item is an image, the parameters can be (but not limited to): date of the image, date at which the image was inserted in the database, presence of a face in the image, etc.

If the entity is a customer, the parameters can include his name, his date of birth, his familial situation, his address, etc.

The database 20 can further comprise a file path which includes a path towards a location in a file system (such as file system 17), for retrieving files comprising raw data. For example, if the item is an image, the file path can include a path to retrieve the true image in the file system. If the entity is a bank account, the file path can include a path to retrieve the bank statements of this bank account in the file system 17.

As mentioned, the database 20 is a key value store database. This type of database allows storing a large amount of data. In addition, it is generally scalable. However, this type of database can be queried only by one key (for example only by one column). The single key for querying the database can however be changed.

For example, if this key is the Entity ID, the database 20 can be queried only by sending queries related to said Entity ID (it is thus not possible to query the database 20 based on one or more of the parameters 1 to n). However, as mentioned, said single key can be changed and can correspond to one of the parameters 1 to n.

FIG. 3 is simplified representation of an embodiment of another database 30 which can be used in the data structure (it can correspond to one of the databases 11 of FIG. 1).

This database is called a “search engine database”, or “search engine”.

FIG. 3 is a representation of the way the data can be stored in this database 30. Other configurations can be used. The database can include various columns Although the representation of FIG. 3 is in the form of a table comprising lines and columns, it is to be understood that in practice the data can be stored using different structures. The representation in the form of a table is used to ease the description.

The different columns of the database 30 can be similar to the columns of the database 20. Thus, the description of these columns is not repeated for FIG. 3.

However, the database 30 can be queried by various keys. This is due to the fact that the database 30 indexes the data for a plurality of keys. For example, the database 30 can be queried based on the Entity ID and based on one or more parameters. Other keys or combination of keys can be used depending on the application.

As a consequence, the structure of the database 30 is different from the structure of the database 20.

Another difference with the database 20 is that the database 30 can be less scalable, and can have a lower time response for some queries.

FIG. 4 is a simplified representation of an embodiment of another database 40 which can be used in the data structure (it can correspond e.g. to one of the databases 11 of FIG. 1).

This database 40 is a called a “graph database”. In this database 40, connections 41 between entities can be stored. The representation of FIG. 4 is a simplified representation for illustrating the way the data are stored in this database 40, and in practice, the data can be stored differently (e.g. in a table, and/or with pointers linking the data, etc.).

The connections can comprise the links between the different entities (or items). It is to be noted that different types of connections can be stored. In addition, according to some embodiments, two entities can be linked by one or more different connections.

For example, if the entities are persons, the connections 41 can include the family link between the persons. Another type of connection can include the fact that the two persons discussed by phone (phone call connection). The connections 41 can include both of these connections.

The types and the number of different connections which are used to represent the data can depend e.g. on the application and on the needs of the user.

According to some embodiments, the database 40 further comprises a “strength” of connection, which can represent the intensity of the connection between the two entities. For example, if the connections include the phone calls that were exchanged, the strength can correspond to the number and/or frequency of the phone calls. For family links, the strength can correspond to the proximity in the family.

The database 40 has a structure which is different from the structures of databases 20 and 30 mentioned above.

The database 40 is particularly adapted to answer queries which are made on the connections between the entities.

According to some embodiments, it is to be noted that the database 40 can be keyless, which means that all the fields stored in this database can be queried.

According to some embodiments, the database 40 stores the data with different levels of access (or levels of permission) for the user. For example, a first user with restricted access can only query a specific type of connection between the entities, whereas a second user with higher access can query the database 40 based on a plurality of connections between the entities. The second user is thus able to obtain more information on the connections between the entities than the first user.

A simple example can be the data that were exchanged between the entities. The first user can access the phone calls and the text messages that were exchanged between the entities, whereas the second user can only access the phone calls that were exchanged between the entities. This example is however not limitative.

FIG. 5 is a simplified representation of an embodiment of a file system 50 which can be used in the data structure (it can correspond to the file system 17 of FIG. 1).

The file system 50 can store various files 51 comprising raw data, such as text files, images, videos, etc. The file system is for example (but not necessarily) an Hadoop Distributed File System (HDFS).

As already mentioned, at least one of the databases of the data structure can store file paths which represent the path to access the files 51 in the file system 50.

It is to be noted that the specific structures of database and data store that were described with respect to FIGS. 2 to 5 are only examples of databases and data stores that can be used in the data structure 10, and other structures and data stores can be used depending on the needs and/or the applications.

It is now described, with reference to FIG. 6, an embodiment of a method of inserting data in the data structure.

The method can comprise a step 60 of receiving raw data to be inserted in the data structure.

The method can comprise a step 61 of saving the raw data in the file system (an embodiment of a file system—see references 17 and 50—is shown in FIGS. 1 and 5) of the data structure.

The method can comprise a step 62 of extracting entities and/or items from the raw data, and assigning to each entity (respectively item) an entity ID (respectively item ID). The definition of the entity (respectively item) can be pre-programmed and stored in a non-transitory memory of the system 15.

Alternatively, or in combination, this definition can be provided by the user.

In addition, various parameters associated to each entity are extracted (step 63). Step 62 can be performed by a processing unit such as the processing unit 16 and/or by another processing unit (not represented). The rules for extracting data from the raw data can be defined in advance and stored in a non-transitory memory, such as a non-transitory memory of the system 15.

For example, if the data belong to an insurance company, it can be known in advance which entities and parameters are relevant (for example the entity can be a customer and the parameters can comprise e.g. “name of the customer”, “date of birth”, “type of insurance policy”, “date of contract”, “claims”, etc.).

In addition, the nature of the raw data that is received by the system 15 can also depend on the technical field of the data, and can be known in advance in some cases. For example, it is expected that the police who are interested in tracking criminality in a city, will get raw data comprising call detail records (CDR).

According to some embodiments, the extraction can be semi-automatic, that is to say that a human operator is involved in the extraction to select the data to extract. The human operator can perform at least some manual tasks and/or use automatic tools (such as text recognition algorithms, image processing algorithms, etc.).

According to some embodiments, the extraction depends on the nature of the raw data. If the raw data comprises a table, the processing unit can extract all columns and lines.

If the raw data comprises an image, the processing unit can perform some pre-processing, such as performing a known per se algorithm for recognizing the presence of a human in the image, etc.

It the raw data comprises text, the processing unit can execute a text recognition algorithm.

Other examples and tools can be used depending on the needs and on the raw data that are received by the system 15.

If applicable, the connections between the entities can be also extracted (see the description of FIG. 4 for examples of connections).

According to some embodiments, the connections between the entities can be extracted using an algorithm (as explained above) which is executed by a processing unit, such as the processing unit 16 and/or by another processing unit (not represented). The algorithm can comprise rules to extract the connections from the data.

According to some embodiments, the connections between the entities can be extracted using heuristics, or using a third party logic.

The types of connections can be defined in advance and can be stored in a non-transitory memory of the system 15.

For example, a non-transitory memory of the system stores that any expression such as “father”, or “mother” present in the raw data corresponds to a family link that needs to be extracted and stored in the data structure.

The method can comprise a step 63 of selecting the database in which the extracted data are to be inserted, and a step 64 of inserting the extracted data into the selected database.

The selection of the database in which the data are to be inserted can be based on at least an insertion criterion.

According to some embodiments, it is known, before the insertion, which data are expected to be directly queried by the user.

According to some embodiments, this knowledge can come from the analysis of the past data queries made by the user using the system 15 (this analysis can be a statistical analysis performed by a processing unit, such as the processing unit 16). This requires that the system 15 was already used by a user, who performed data queries on the data that were inserted in the data structure.

According to some embodiments, this knowledge can come from the technical field of the data. Indeed, the type of query generally depends on the technical field. In a given technical field, it is expected that some data will be directly queried since they are of direct interest for the user in this technical field.

According to some embodiments, this knowledge can come from inputs that the user provides in advance on the type of data queries he intends to make, so that the system 51 can be tuned to be adapted to his needs.

A combination of these embodiments can be performed to select the database in which the extracted data will be inserted.

According to some embodiments, the method can comprise inserting data that are expected to be directly queried by a user in a database of the data structure which is queriable by a plurality of keys.

For example, if the data are data stored by the police on criminality in a city, data which are related to the name and the address of people are expected to be directly queried by the user (that is to say that it is expected that the user will perform direct data queries on these parameters). Thus, these data can be inserted in a database such as the database of FIG. 3, which is queriable by a plurality of keys.

According to some embodiments, the method can comprise inserting data that are not expected to be directly queried by the user in a database of the data structure which is queriable only by a single key.

For example, if the data are data stored by the police on criminality in a city, and the data comprise images of people (“item”) and the parameters of the item include for example the date at which the image was received by the system and the date at which the image was taken, it is not expected that the user will perform direct queries on these data. These data will generally be used to enrich (if applicable and if necessary) the results of the data query. These data can be viewed more as indicators rather than information of direct interest to the user.

Thus, these data can be inserted in a database such as the database of FIG. 2, which is queriable only by a single key.

According to some embodiments, the method can comprise inserting data that are classified with respect to a given key in a database of the data structure which is queriable by a single key corresponding to said given key (such as the database of FIG. 2). For example, if the extracted data are classified by the entity ID, these data can be inserted in a key value store (such as the database of FIG. 2), if said database is queriable by the entity ID.

According to some embodiments, the processing unit detects if the data are related to connections between entities. For example, the system can store predefined rules in a non-transitory memory which defines which data correspond to connections between entities. A non limitative and exemplary connection can be a phone call between two entities (persons) which is defined in the system as a connection between two entities (persons). In this case, according to some embodiments, the method can comprise inserting the data which are related to connections between entities into a database which is more adapted to handle such data than the other database. For example, these data can be inserted in the database of FIG. 4, which is a graph database).

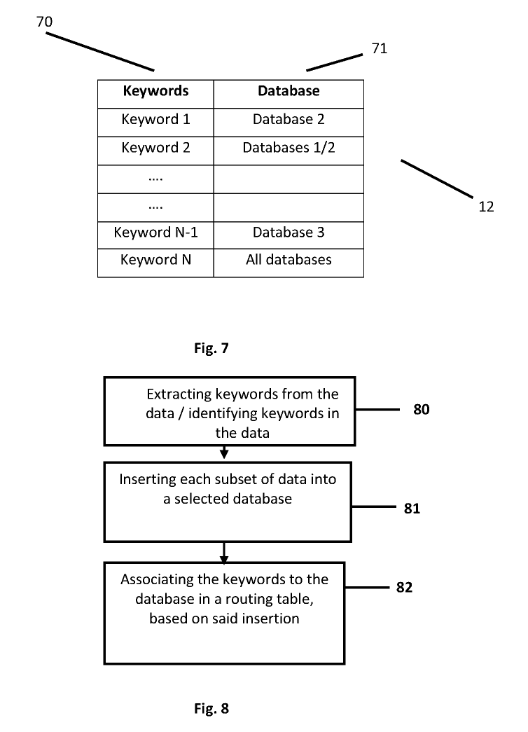

Attention is now drawn to FIG. 7 which describes an embodiment of a routing table 12. The routing table 12 was already mentioned with respect to FIG. 1.

The routing table 12 can be stored in a memory (not represented), such as a memory of the system 15 and/or of the data structure 10. The routing table 12 can be stored in a non transitory memory of the system 15. According to some embodiments, during operation of the system 15, the routing table 12 can be stored in a transitory memory (not represented), for example in a cache memory, in order to reduce the access time to the routing table 12.

The routing table 12 can be used in particular for facilitating data queries in the data structure. Embodiments which use this routing table 12 will be described later in the specification. According to some embodiments, and as described later in the specification, the content of the routing table 12 is dynamic and can be updated and/or optimized over time.

As shown in FIG. 7, the routing table 12 comprises one or more keywords 70. A keyword includes a sequence of strings and/or of numeric values. According to some embodiments, the keyword can comprise word, or a plurality of words, or an expression, or a sentence, etc. The words are not necessarily intelligible words and can comprise codes which are relevant in a given technical field.

In the routing table 12, each keyword 70 is associated to at least a database of the data structure.

In the example of FIG. 7, keyword 1 is associated only to database 2. Keyword 2 is associated to databases 1 and 2. Keyword N−1 is associated to database 3. Keyword N is associated to all databases of the data structure.

As explained later in the specification, this routing table can help directing sub-queries built from the user data query towards the relevant database(s).

According to some embodiments, a keyword can be at least one of the parameters of the entities or items stored in at least one of the databases. In a non limiting example, an entity is a person and the parameters comprise at least his address. A keyword can be the word “address”.

According to some embodiments, a keyword can comprise a word or a group of words (and/or even numerical values if applicable) which are related to the structure of at least one of the databases.

It has already been mentioned that a graph database (such as the database of FIG. 4) can store connections between entities according to some embodiments (if necessary with the strength of the connections). Thus, in a non limiting example, a keyword can be the word “connection” or “strength”.

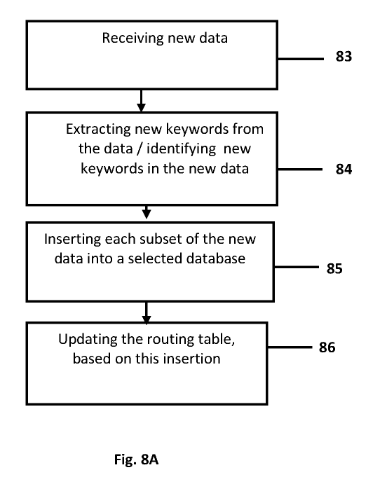

FIG. 8 illustrates an embodiment of a method of building a routing table. This method can be performed during the insertion of the data in the database. An example of this insertion was described e.g. with reference to FIG. 6. These steps can be performed by a processing unit such as the processing unit 16 and/or by another processing unit.

The method can comprise a step 80 of extracting keywords from the data to be inserted in the data structure. This step can be performed by a processing unit such as the processing unit 16, or by another processing unit. According to some embodiments, the extraction can comprise an intervention of a human operator. For example, the human operator can select a subset of the keywords among the ones that were extracted by the processing unit.

For example, if the data are in the form of a table, the processing unit can extract the name of the lines and/or of the columns, which can thus be stored as keywords.

For example, if the table comprises the name, the address, the date of birth and the gender of people, keywords can be “name”, “address”, “date of birth” and “gender”.

According to some embodiments, the parameters of the data (see e.g. step 62 of FIG. 6, which describe the extraction of the values of the parameters from the raw data for each entity/item) are extracted by the processing unit and stored as keywords.

For example, if the entity is a person, and the data comprise the call detail records of a person (which comprise e.g. the phone number of the caller, the phone number of the receiver and the date at which the phone call was made), the parameters can be “phone number of the caller”, “phone number of the receiver”, “date of the phone call”, etc. At step 62 of FIG. 6, the values of these parameters are extracted. In the present step 80, the name of the parameters is stored as keywords in the routing table.

According to some embodiments, the processing unit communicates with a non-transitory memory (which can be part of the system 15) which stores a list of possible keywords that are relevant in the technical field of the data.

In this case, the step 80 comprises identifying keywords present in the raw data (or in the extracted data from the raw data) to be inserted in the data structure based on said predefined list.

This list can be obtained from an a priori knowledge of relevant data in the technical field (each technical field has generally classical keywords which are of interest in this field for classifying data).

In some cases, an input of the user in the system (using e.g. the querying module) can be taken into account to build this list.

The processing unit then tries to identify if some keywords of the list are present in the data to be inserted. If the data comprise text, the processing unit can perform a text comparison between the expressions present in the text and the keywords present in the list. If this comparison provides that some of the words present in the text match with keywords of the list, these words can be stored as keywords at step 80.

The method of FIG. 8 can then comprise a step 81 of inserting the data into a selected database. The selection of the database and the insertion of the data were already described with respect to step 64 of FIG. 6.

At step 82, the routing table can be built.

If at least a keyword was extracted or identified from a given subset of data, which was inserted in at least a database, then the processing unit can store in the routing table said keyword and can associate it to said database.

Indeed, since this subset of data was inserted in this database, this means that queries related to this keyword should be addressed to this database. The association of the keywords to the relevant database in the routing table can help directing the sub-queries related to these keywords to the adapted database.

For example, the keywords may comprise “name of person”, “date of birth”, “age”, “father of”. Data that comprised the keywords “name of person”, “date of birth” and “age” were inserted in the database of FIG. 4 (search engine), and data comprising the keyword “father of” were inserted in the database of FIG. 5 (graph database). The keywords “name of person”, “date of birth” and “age” can be associated to the database of FIG. 4 in the routing table, and the keyword “father of” can be associated to the database of FIG. 5 in the routing table.

If keywords were extracted from data that were inserted into a plurality of databases, then the keywords present in these data can be associated to this plurality of databases in the routing table.

According to some embodiments, some keywords are associated by default to the plurality of databases (such as keyword N in FIG. 7).

It will be described later that the routing table can be dynamic, that is to say that the routing table can be updated and/or optimized over time, depending e.g. on the new input of the data structure and/or on the data queries performed by the user.

In addition, it was already mentioned that some keywords and the associated database can be pre-programmed in the routing table. For example, the word “connection” can be already pre-programmed as associated at least to the graph database (if applicable) since the queries related to connections between entities will be generally addressed to the graph database.

According to some embodiments, when new data are inserted into the data structure, the method of FIG. 8 can be applied again (see FIG. 8A). These steps can be performed by a processing unit such as the processing unit 16 and/or by another processing unit.

If new keywords are extracted and/or identified in at least a subset of the new data (steps 83, 84), they can be associated to at least one of the databases depending on the insertion of this subset of new data.

For example, if the routing table comprises keywords 1 to N, and the new subset of data comprises keyword N+1, and the new subset of data is inserted into database X (step 85—using for example the insertion method of FIG. 6), the keyword N+1 can be associated to the database X in the routing table.

If the subset of new data comprises existing keywords (such as keyword N−1, associated to database Y in the current routing table), but this subset of new data is inserted into a different database X, then the routing table can be updated by associating the existing keyword (N−1) also to database X in the routing table. Thus, this keyword is now associated to database X and Y in the routing table. Alternatively, the processing unit can remove the previous association and replace it with this new association.

As a consequence, the routing table is updated (step 86).

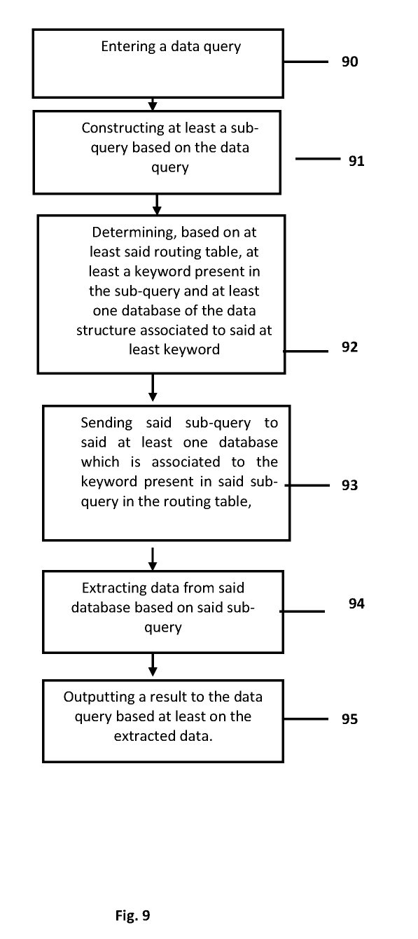

FIG. 9 illustrates an embodiment of a method of querying data into the data structure.

The method can comprise a step 90 in which a user enters a data query. According to some embodiments, the user enters the data query using the querying module 19 (see FIG. 1).

According to some embodiments, the querying module allows the user selecting various data that he can query in the database, and which allows the user to enter values for these data.

According to some embodiments, the querying module comprises predefined data that can be queried by the user.

These predefined data can correspond for example to data that are expected to be queried by most of the users, which is why they are predefined in the querying module. The user can then enter values for these data, and define how these data need to be aggregated in the data query.

For example (this example is not limitative), the querying module allows selecting “name of the person”, “age”, “date of birth”, and allows the user to assign values for these data.

According to some embodiments, the querying module allows the user performing queries on a plurality of data, such as an aggregation of different data, a combination of different data, or an alternative between different data.

For example, the data query can comprise a query on multiple parameters. The user is thus able to define the aggregation that he is expecting between the different parameters using the querying module.

An example of a data query can be a query on all persons whose age is under 60 and who are connected to a person called “Mr X”.

Another example of a data query can be a query on all persons who are connected to “Mr X” or to “Mr Y”.

These examples are however not limitative.

According to some embodiments, the querying module allows the user entering the data query in a structured way, using expressions and if necessary Boolean operators. For example, the user can write “age<60” AND “connected to Mr X”. This is however a non limitative example.

According to some embodiments, the data query can be expressed using other programming languages, and then for example an API can be used to convert the input of the user before it is sent to the system 15, as already mentioned with respect to the querying module 19.

Other interfaces can be used depending on the applications and on the needs.

The method can then comprise a step 91 of constructing at least a sub-query based on the data query (this step can be performed by a processing unit such as the processing unit 16 and/or by another processing unit).

As described later in the specification, according to some embodiments, the method can comprise building a plurality of sub-queries based on the data query.

According to some embodiments, the sub-query can be expressed in an internal programming language of the system.

According to some embodiments, this programming language is an object programming language, which expresses the sub-query using general functions comprising e.g. the fields that are sought by the user and the values for these fields.

According to some embodiments, the sub-query can be expressed using at least three fields, which comprise “field name”, “condition” and “value”. Other representations can be used depending on the application.

Indeed, the data query generally comprises a plurality of words (which include any group of strings, which can comprise a single word or a group of words) and values (which can comprise numerical values and/or textual characters depending on the nature of the data) associated to these words. In addition, the data query generally comprises a condition which links the plurality of words to the values.

For example, if the user selected in the querying module the word “age” with the condition “less than” and the value “60”, the sub-query can be expressed as the following:
Field condition=“Age”;
Condition=“Less than”;
Value=“60”.

If the user entered the data query using plain text, the processing unit can for example detect that the first expression corresponds to the field condition, the second expression to the condition, and the third expression to the value.

According to some embodiments, the sub-query can also represent mathematical operations, such as the average of data, the sum of data, etc. An adapted field can be used in the programming language which is used to construct the sub-query.

Other examples of constructing the sub-query can be used depending on the needs and the application.

If the data query comprises a plurality of requests, the processing unit can construct a plurality of sub-queries.

For example, if the user entered in the querying module a data query on the people under age “60” and who are connected to “Mr X”, the querying module can build a first sub-query in which:
Field condition=“Age”;
Condition=“Less than”;
Value=“60”,
   and a second sub-query in which:
Field condition=“Connected to”;
Condition=“Connected to”;
Value=“Mr X”.

According to some embodiments, the processing unit can deduce from a selection of the user in the querying module the way the data query has to be split into different sub-queries. Indeed, the user generally needs to enter sequentially or separately each component of his data query.

If the user enters his data query using plain text and in a structured way, then the processing unit can deduce from e.g. the Boolean operators (“AND”, “OR”) or from the syntax (parenthesis, etc.) of the data query, the way the data query has to be split into different sub-queries.

The method can comprise a step 92 of determining, based at least on the routing table (see e.g. FIG. 7), at least a keyword present in the sub-query and at least one database of the data structure associated to said at least keyword.

The processing unit can read in the different fields of the sub-query the different words (and/or group of words and/or group of strings and/or numerical values) that are present in the sub-query and compare them to the content of the routing table.

If this comparison provides a matching result, this means that at least part of the fields of the sub-query is a keyword present in the routing table. The processing unit then reads in the routing table the database (or the databases) to which this keyword is associated.

For example, if the user asked a data query for finding people under the age of 65, the processing unit can identify that the word “age” is a keyword associated to the database of FIG. 5 (search engine).

If no keyword is identified in the sub-query, according to some embodiments, the sub-query can be ignored.

The sub-query is then sent (step 93) to the database associated to the keyword in the routing table. It will be explained later that according to some embodiments, an adapter can convert the sub-query into a programming language which is understandable by each database.

The processing unit then extracts (step 94) the data from the database based on this sub-query.

In the example given above (people who are younger than 65), the result provided to the sub-query can comprise a list of entities (here the entities are persons) who are younger than 65.

The processing unit can then output (step 95) a result to the data query based at least on the extracted data. The result can be for example output e.g. on a user interface (which can be external to the system 15). The user interface can comprise a visual view of the entities, if necessary enriched with metadata associated to each entity (such as image, etc.). These metadata can be extracted e.g. from the key value store database which can store the parameters of each entity.

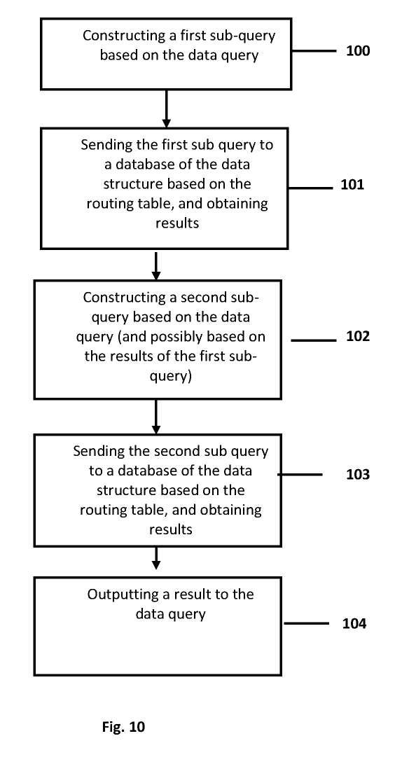

In the method of FIG. 10, an embodiment is described wherein two sub-queries are constructed based on the data query. This method applies mutatis mutandis to the use of more than two sub-queries. It is to be noted that the representation of FIG. 10 does not necessarily express the order of the steps that are performed in this method, and at least some of steps can be performed in another order.

For example, the data query is to find people of age “65” and living in “Paris”.

As illustrated, the processing unit builds a first sub-query (step 100). The first sub-query can for example express the fact that people who are 65 years old are searched. A non limiting expression of this sub-query can be:
Field condition=“Age”;
Condition=“Equal”;
Value=“65”.

The processing unit then reads in the routing table if keywords of the routing table are present in the first sub-query. In this example, it has identified a first keyword (this first keyword can be “age”). It identifies at least a database associated to said first keyword, and sends the first sub-query to said database, to obtain results to this first sub-query (step 102).

The processing unit builds a second sub-query (step 103). A non limiting expression of this second sub-query can be:
Field condition=“Location”;
Condition=“Equal”;
Value=“Paris”.

According to some embodiments, the second sub-query is constructed as being dependent on the first sub-query. Indeed, in this example, the second sub-query has to find entities among the entities already found by the first sub-query. In this specific example, the second sub-query has to find people located in Paris among the people who are 65 years old.

Thus, the second sub-query can comprise an additional field which comprises a restriction of the search to the entities found by the first sub-query.

The processing unit sends (step 103) the second sub-query to the database which is associated to the second keyword.

Then, the processing unit outputs (step 104) a result to the data query based on the results of the second sub-query.

According to some embodiments, the first sub-query and the second sub-query are separately sent to the relevant database based on the routing table. The first sub-query outputs “results 1” and the second sub-query outputs “results 2”. Then, the processing unit outputs a result which is the aggregation of “results 1” and “results 2”. In this case, the second sub-query is not constructed as being limited to the results of the first sub-query.

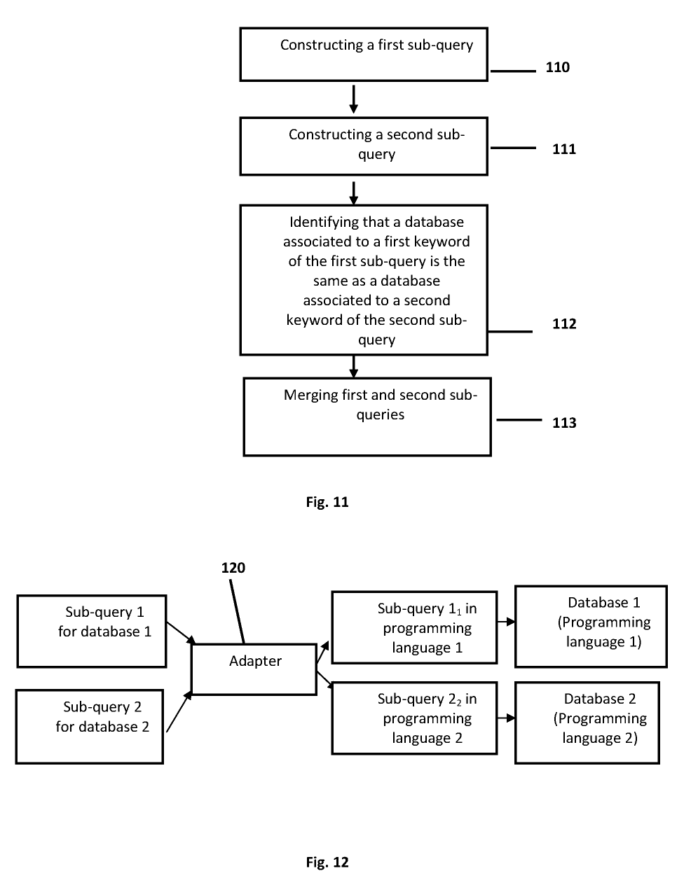

In some cases, the processing unit constructs a first sub-query and a second sub-query (see steps 110 and 111 of FIG. 11). It is to be noted that the representation of FIG. 11 does not necessarily express the order of the steps that are performed in this method, and at least some of steps can be performed in another order.

The processing unit identifies that a first keyword of the first sub-query and a second keyword of the second sub-query are associated to the same database in the routing table (see step 112 of FIG. 11).

In this case, in order to avoid sending two separate requests to the same database, the processing unit can merge the first sub-query and the second sub-query into a consolidated sub-query (step 113), which can be sent to said database.

For example, if the first sub-query corresponds to a query which is “date of birth” and is in “time interval X”, and “date of birth” is a keyword associated to database 1, and the second sub-query corresponds to a query which is “location” is in “city Y”, and “location” is a keyword associated also to database 1, then a consolidated sub-query can be sent to the database 1, which could comprise “date of birth”=“time interval X” AND “location”=“city Y”.

This applies to a larger number of sub-queries.

Attention is now referred to FIG. 12. According to some embodiments, at least a first database of the data structure is queriable using a first programming language, and at least a second database of the data structure is queriable using a second programming language.

According to some embodiments, the queries that are sent to a key store value database (see e.g. FIG. 3) can be programmed in “CQL” (Cassandra querying language)”.

According to some embodiments, the queries that are sent to a search engine database (see e.g. FIG. 4) can be programmed in “DSL”.

According to some embodiments, the queries that are sent to a graph database (see e.g. FIG. 5) can be programmed in “Cypher”.

In order to be able to convert the data queries/sub-queries in the appropriate programming language for each database, the system 15 can further comprise an adapter 120 (represented in FIG. 1 as reference 18).

Although the adapter 120 is represented as part of the system 15, according to some embodiments, the adapter 120 is not “visible” as such for an external user or programmer. As mentioned above in the description of the querying module, the system can comprise an API (such as but not limited to a RESTful API) with which the user or the programmer can communicate.

According to some embodiments, the programmer can build data queries (for example, but not limited to, using a programming language Jason) and send them to the API, which can convert them into a programming language used in the system 15. As mentioned below, the adapter can then convert the corresponding data queries/sub-queries into the programming language specific to each database.

The adapter 120 can be operable on a processing unit, such as the processing unit 16, and/or is operable on another processing unit.

According to some embodiments, the adapter 120 converts at least part of the sub-query into a programming language which is understandable by each database to which the sub-query is sent. According to some embodiments, the adapter is pre-programmed to perform this conversion/adaptation for each database.

In FIG. 12, the adapter 120 receives a sub-query “1” which was constructed by the processing unit according to the methods described previously. According to the routing table, this sub-query “1” has for example to be sent to the database “1”. This sub-query “1” cannot be understood by the database “1”, since this database “1” only understands the programming language “1”. The adapter converts the sub-query “1” into a sub-query “1₁”, expressed in the programming language “1”.

The adapter 120 performs the same tasks for the sub-query “2” that needs to be sent to the database 2 which only understands the programming language “2”.

Although a unique adapter 120 was represented, according to some embodiments, an adapter specific to each database or to a subset of databases is used.

According to some embodiments, the sub-queries are expressed, before their conversion by the adapter, in a programming language which is independent from a programming language understandable by each database. For example, as mentioned above, the processing unit can express the sub-query in an object programming language. This object programming language uses for example functions and/or fields which are not specific to the programming language of a particular database of the data structure. Non limiting examples were provided above.

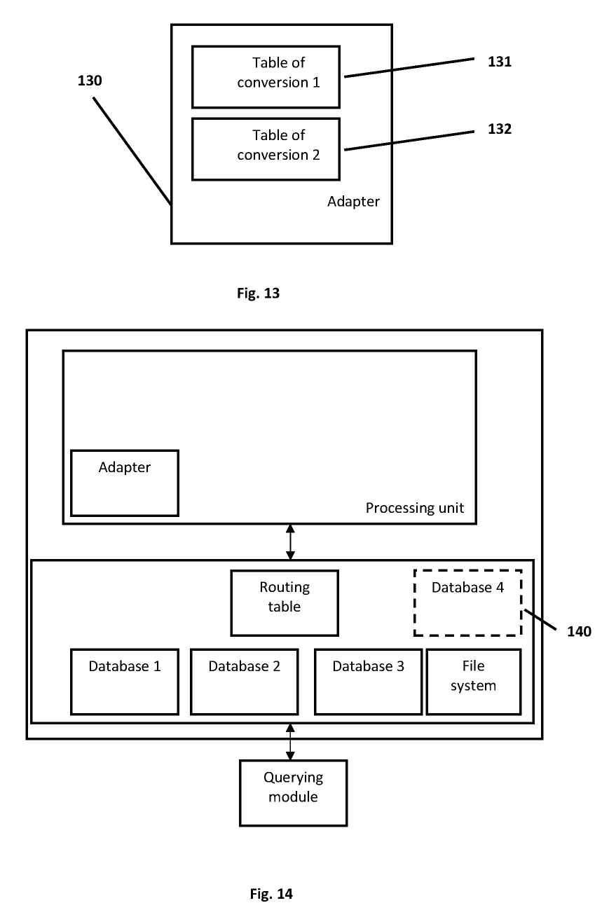

FIG. 13 illustrates an embodiment of an adapter 130. As shown, the adapter 130 comprises at least a table of conversion 131 (or it can communicate with such a table of conversion). This table of conversion 131 is relevant for database “1”. In particular, it stores, for each function of the programming language used for expressing the sub-queries, the equivalent function in the programming language “1” of the database “1”.

According to some embodiments, the table of conversion comprises an execution function which receives as input the values of the fields and arguments present in the sub-query and automatically converts them into fields and arguments that can be inserted in a function expressed in the programming language of the database.

Thus, the adapter can convert the sub-queries into the programming language by using this table of conversion “1”.

Similarly, the adapter can store a table of conversion “2” which stores, for each function of the programming language used for expressing the sub-queries, the equivalent function in the programming language “2” of the database “2”.

According to some embodiments, the adapter receives each sub-query and can identify the functions used in this sub-query, and extract the different fields and arguments used for these functions. It uses the table of conversion to convert these functions and the fields/arguments present in these functions to the corresponding functions as understandable by the database. It then outputs the sub-query as translated into the relevant programming language of the database to which the sub-query has to be sent.

If a given sub-query “i” has to be sent to a plurality of n databases (for example based on the content of the routing table), the adapter 130 can convert this sub-query “i” into various n sub-queries “i₁”, “i₂”, . . . , “iₙ”, wherein each sub-query iⱼ (j from 1 to n) is expressed in the programming language understandable by the database “j”.

For example, a database of the data structure understands the programming language “SQL”, another database of the data structure understands the programming language “DSL”, and another database of the data structure understands the programming language “Cypher”.

The adapter can comprise a table of conversion for SQL, a table of conversion for DSL and a table of conversion for Cypher.

Alternatively, the system can comprise a plurality of different adapters, wherein each adapter is configured to convert a sub-query into the programming language of a different database.

In a purely illustrative and non limiting example, the user queries all people who are between 25 and 35 years old, who are living in Tel-Aviv and who are connected to Israeli people.

In this example, we assume that the fields “age” and “living city” are stored in a search engine database (see e.g. FIG. 3) and the field “connected to” is stored in a graph database (see e.g. FIG. 4).

A first sub-query (which merges the sub-query on the age of the people and the sub-query on the living city of the people, since these fields are stored in the same database) can be built for the search engine database for example as following:
[field: age, condition: range, values: 25, 35 & field: address, condition: equals, value: Tel-Aviv].

A second sub-query can be built for querying the people who are connected to Israeli people, based on the results of the first sub-query. This second sub-query can be sent to the graph database, and can be expressed for example as following:
[field: Connection_Type, condition: equals, value: Connected to].

The adapter can convert the first sub-query into the programming language of the search engine database (which is for example DSL), as following:

```
“query”: {
  “bool”: {
  “must”: [
    {
    “match”: {
      “address”: “Tel-Aviv”
    }
    },
    “range” : {
    “field” : “date_of_birth”,
    “gt” : 25,
    “lt” : 35
    }
  ]
  }
}
```

The search engine database can return a list of entity IDs (“id list”). Then the adapter can convert the second sub-query into the programming language of the graph database. This second sub-query is based on the result of the first sub-query (“id list”):

MATCH (n)→[r:CONNECTED_TO]→(m) WHERE n.id in[*id list*] and m.id in [*id list*] RETURN m,n

A second list of entity IDs can be extracted from the result output by the graph database and if necessary, the information linked to these entity IDs can be queried for example from the search engine database.

FIG. 14 illustrates an embodiment in which the adapter can facilitate the update of the data structure.

In this embodiment, the data structure initially comprises databases 1 to 3, as already shown in FIG. 1.

The database 1 can be queried using programming language 1, the database 2 can be queried using programming language 2 and the database 3 can be queried using programming language 3.

A new database 4 is now inserted in the data structure (reference 140 in FIG. 14). This new database 4 uses programming language 4.

Since the afore-mentioned adapter is used, according to some embodiments it is not necessary to change the programming language in which the sub-queries are expressed in the system.

In particular, a querying layer of the data structure which computes each sub-query to be sent to each database based on the data query can remain unchanged. This querying layer is for example operable on the processing unit 16.

In particular, according to some embodiments, the different fields and functions used for constructing the sub-queries can remain unchanged.

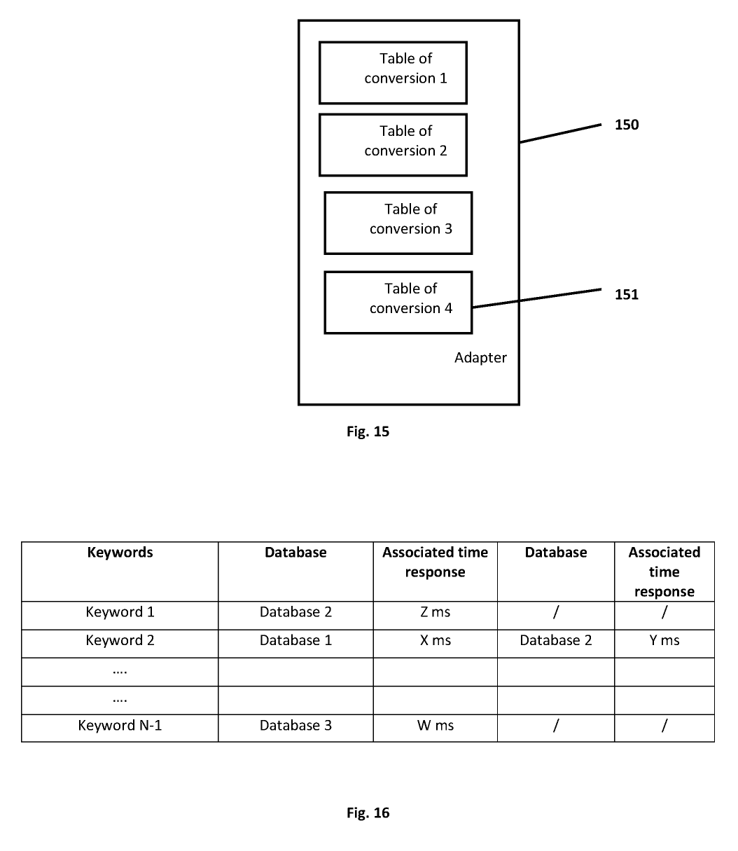

As shown in FIG. 15, in order to take into account the introduction of the new database 4, the adapter 150 is updated by introducing a new table of conversion 4 (reference 151) which converts the sub-queries into the programming language of this new database 4.

In addition, since a new database 4 is inserted into the system, the routing table can also be updated.

If data are already stored in the database 4, the update can comprise extracting keywords from the data present in the new database 4 (see e.g. step 80 in FIG. 8, for examples of extraction), and associating them to the new database 4 in the routing table.

If data of the data structure are redistributed so that part of the data are now stored in database 4, this update can comprise extracting keywords from the data which are moved to the new database 4 (see e.g. step 80 in FIG. 8, for examples of extraction), and associating them to the new database 4 in the routing table.

If new data are inserted into the data structure so that at least part of the data are inserted in the database 4, a method similar to what was described with reference to FIG. 8A can be used.

It will now be described an embodiment of updating and/or optimizing the routing table.

According to some embodiments, the routing table is dynamic. In particular, the association of the keywords with the databases in the routing table can be updated over time, in particular for optimizing the routing table and thus the performance of the data queries.

A possible embodiment is illustrated in FIG. 16.

In this embodiment, the method comprises for at least a keyword associated to a plurality of databases in the routing table (in this example Keyword 2 is associated to databases 1 and 2), a step of sending a sub-query to each of said plurality of databases. If a sub-query contains the word “keyword 2”, it will be sent to database 1 and to database 2.

The performance of each sub-query can be monitored. In this example, the time response can be measured, for example by the processing unit of the system. For keyword 2, a sub-query was sent to database 1 which provided the results with a time response of X ms, and a sub-query was sent to the database 2 which provided the results with a time response of Y ms (Y<X).

According to some embodiments, for subsequent sub-queries which comprise the word “keyword 2”, the routing table can comprise an indication that the sub-query should be sent preferably to database 2. This indication can for example comprise a ranking value which ranks the database associated to each keyword based for example on the time response of previous data queries. As mentioned later in the specification, these indications can vary over time, depending on the variation of various factors.

According to some embodiments, the routing table is updated so that “keyword 2” is associated only to database 2 (since it provided at this stage the best time response). If necessary, the processing unit can keep track in a non-transitory memory that database 1 was also associated to keyword 2 in the past.

According to some embodiments, the time response is measured for previous sub-queries comprising a keyword, and stored e.g. in the routing table, so that a current sub-query, which comprises said keyword, is sent to the database for which the time response is the lowest. In this case, it is not necessary to change the association of the keywords to the database in the routing table.

As mentioned, these updates and optimizations can be performed several times (in a non limiting example, they are performed every night and/or when the user is not using the system).

In a non limiting example, they can be performed several times per second and periodically be saved to a persistent storage.

According to some embodiments, the time response for each couple comprising a keyword and a database is measured and stored, e.g. in the routing table. This is shown in FIG. 16.

The time response measured for each keyword (which can be measured for at least a past sub-query or for a plurality of past sub-queries) can be used e.g. when a data query is divided into a plurality of sub-queries.

As shown e.g. in FIG. 10, at least a first sub-query (based on a first keyword) and a second sub-query (based on a second keyword) are built and sent to the relevant database.

According to some embodiments, the processing unit can use the time response which is measured for each keyword to choose if the processing unit should begin by sending the first sub-query or by sending the second sub-query. Indeed, it is generally interesting to begin with a sub-query which has the lowest time response, so as to reduce the number of results in which a search has to be made. Then, the second sub-query can be built to perform a search based on the results of the first sub-query. This can be applied to a plurality of sub-queries.

It has been shown that the time response can be used to update/optimize the routing table, and/or to control the sending of the subsequent sub-queries towards the different databases (that is to say without necessarily changing the association of the keywords to the databases in the routing table).

More generally, the system can use various data to update/optimize the routing table, and/or to control the orientation of the subsequent sub-queries towards the different databases.

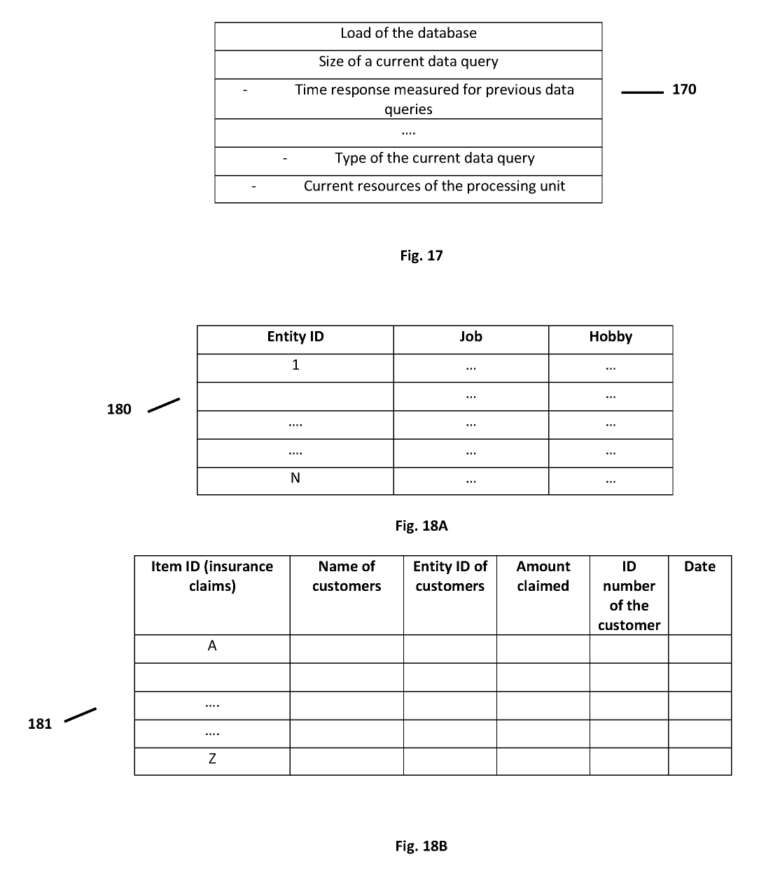

FIG. 17 illustrates a vector 170 (which can be seen as an optimization vector) which can be used in the system. This vector can be stored in the routing table and/or in another non-transitory memory of the system. It is to be noted that the representation as a vector is not limiting and other representations can be used.

The vector can comprise at least one of the parameters shown in FIG. 17, or a plurality of those, or other parameters depending on the needs and on the application. According to some embodiments, this vector is built for each database.

As shown, the vector can store parameters which reflect the load of the database. The load of the database reflects the ratio between the volume of queries which are currently handled by the database with respect to the available resources of the processing unit on which the database is running. This load can be measured e.g. by measuring the load of the server(s) on which the database is running.

The vector can also comprise parameters reflecting the size of the current data query or sub-query.

The vector can also comprise parameters reflecting the time response measured for previous data queries/sub-queries. This time response can be measured e.g. for each database, or for each keyword, or for each couple comprising a keyword and a database. The time response can also be measured for particular values asked in association to a given keyword (for example “age” and the range “[30;60]”).

The vector can also comprise parameters reflecting the type of the current data query.

The vector can also comprise parameters reflecting the current resources of the processing unit (also called actual CPU machine).

The vector can also comprise other parameters such as (but not limited to): specific user preferences, machine characteristics, query time measurements, common sub queries, query frequency distribution over time, etc.

At least one or a plurality of these parameters can be used to control the data query.

In particular, according to some embodiments, the routing table is updated based at least on one of these parameters.

This update can comprise, for a keyword associated to a plurality of databases, selecting a preferred database to which the sub-query associated to this keyword should be sent. The association of the keyword to the preferred database can be stored in the routing table.

It is to be noted that this association can vary over time depending on the evolution of the various parameters.

This update can also comprise ranking the database associated to each keyword.

This update can also comprise ranking the keywords in the routing table. This can be used to select the order in which the sub-queries should be sent to the relevant database.

According to other embodiments, the routing table is not necessarily updated but the processing unit selects to which database subsequent sub-queries should be sent based on these parameters.

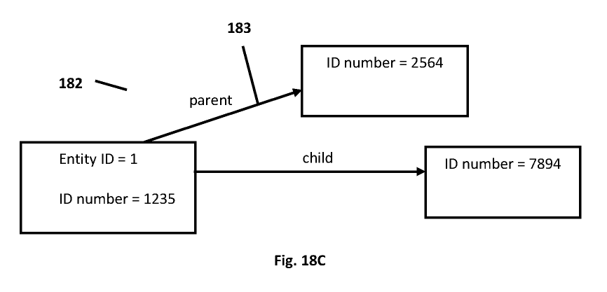

FIGS. 18A to 18C illustrate a simplified and non limiting example in which a data query is performed. This example is for illustration only. In this example, the routing table is not dynamic. The raw data that were received by the system comprises:
The list of all insurance claims of a insurance company over at least 100 years, with the names of the customers,
The list of customers with their ID numbers and the ID number of their parents and children,
General data on the customers (such as their job, hobbies, etc.).

The data structure comprises in this example a key value store 180, in which the general data on the customers can be stored (FIG. 18A). An entity ID is assigned to each customer. The routing table is updated accordingly by associating the words “job” and “hobbies” to the key value store in this routing table.

The list of all insurance claims associated to the customers can be stored in the search engine database 181 (FIG. 18B). An item ID is assigned to each insurance claims. The routing table is updated accordingly by associating the words “insurance claims”, and “customers” to the search engine.

For each new ID number, the system can add it to the graph database (182 in FIG. 18C) together with the links 183 with their parents and children. The routing table is updated accordingly by associating e.g. the keywords “parent” and “children” to the graph database in this routing table.

The user asks for the ID number of all children of customers for which there was an insurance claim. The processing unit can build a sub-query to get all entities for which an insurance claim was made. This sub-query is sent to the search engine (based on the routing table which stores the expression “insurance claims” and its association with the search engine). The search engine returns a list of entity IDs. A second sub-query is sent to the graph database, to get all people who are stored as “children” of the people present in this list of entity IDs, and to extract the corresponding ID number.

The processing unit then outputs the result as a list of ID numbers.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer/processing unit. Likewise, the invention contemplates a computer program being readable by a computer/processing unit for executing the method of the invention. The invention further contemplates a non-transitory computer-readable memory tangibly embodying a program of instructions executable by the computer/processing unit for executing the method of the invention.

Those skilled in the art will readily appreciate that various modifications and changes can be applied to the embodiments of the invention as hereinbefore described without departing from its scope, defined in and by the appended claims.

1. A method of querying data in a data structure comprising a plurality of databases, at least a first database of the plurality of databases having a different structure than a second database of the plurality of databases, the method comprising, by at least a processing unit:
providing at least a routing table associating to each keyword of a list of keywords at least one database of the data structure,
for a data query:
constructing at least a sub-query based on the data query,
determining, based on at least said routing table, at least a keyword present in the sub-query and at least one database of the data structure associated to said at least keyword,
sending said sub-query to said at least one database which is associated to the keyword present in said sub-query in the routing table,
extracting data from said at least one database based on said sub-query, and
outputting a result to the data query based at least on the extracted data.

2. The method of claim 1, comprising:
constructing a first sub-query based on the data query,
sending the first sub-query to at least a database of the data structure which is associated in the routing table to a first keyword present in the first sub-query,
constructing a second sub-query based on the data query,
sending the second sub-query to at least a database of the data structure which is associated in the routing table to a second keyword present in the second sub-query, and
outputting a result to the data query based at least on the results of the first and second sub-queries.

3. The method of claim 1, comprising:
constructing a first sub-query based on the data query,
sending the first sub-query to at least a database of the data structure which is associated in the routing table to a first keyword of the first sub-query, for providing first results,
constructing a second sub-query based on the data query and on the first results,
sending the second sub-query to at least a database of the data structure which is associated in the routing table to a second keyword present in the second sub-query, and
outputting a result to the data query based at least on the results of the second sub-query.

4. The method of claim 1, comprising constructing a first sub-query based on the data query and a second sub-query based on the data query, wherein if a first keyword of the first sub-query and a second keyword of the second sub-query are associated to the same database in the routing table, the method comprises merging the first sub-query and the second sub-query into a consolidated sub-query.

5. The method of claim 1, wherein the plurality of databases comprises at least one of a key value store database, a search engine database, and a graph database.

6. The method of claim 1, wherein the data structure further comprises a file system.

7. The method of claim 1, comprising aggregating the data extracted from each database, to output the result to the data query based on said aggregation.

8. The method of claim 1, wherein the sub-query is expressed in a programming language which is independent from a programming language understandable by each database.

9. The method of claim 1, wherein an adapter converts at least part of the sub-query in a programming language which is understandable by each database to which the sub-query is sent.

10. The method of claim 1, comprising updating the routing table when new data are inserted in the data structure, said update comprising associating at least a keyword present in the new data to at least a database of the data structure.

11. The method of claim 1, comprising updating the routing table when a new database is inserted into the data structure, said update comprising associating at least a keyword to said new database in the routing table.

12. The method of claim 1, wherein when a new database is inserted into the data structure, the method comprises using an adapter which converts the sub-query which is to be sent to said new database in a programming language which is understandable by said new database.

13. The method of claim 1, wherein a querying layer of the system which computes each sub-query to be sent to each database based on the data query remains unchanged when a new database is inserted in the data structure.

14. The method of claim 1, comprising, when data are inserted into at least a database of the data structure:
extracting at least a keyword from said data, and
associating in the routing table said keyword to the database in which said data were inserted.

15. The method of claim 1, comprising updating the association of the keywords with the database in the routing table during time.

16. The method of claim 1, comprising:
measuring a time response for a plurality of previous data queries, and
updating the routing table and/or selecting the database to which a current sub-query is sent based at least on said time response.

17. The method of claim 1, comprising:
measuring a first time response for at least a previous sub-query comprising at least a first keyword and a second time response for at least a previous sub-query comprising at least a second keyword,
constructing at least a first sub-query and a second sub-query based on the data query, wherein the first sub-query comprises said first keyword and the second sub-query comprises said second keyword, wherein the order in which the first sub-query and the second sub-query are executed is based on a comparison between the first time response and the second time response.

18. The method of claim 1, comprising, for at least a keyword associated to a plurality of databases in the routing table, sending a sub-query to each database, measuring performances of each sub-query and associating one of the databases to said keyword in the routing table based on a comparison between the performances of each sub-query.

19. The method of claim 1, comprising updating the routing table and/or selecting the database to which a current sub-query is sent based at least on:
Current and/or past load of the databases;
Size of a current data query;
Time response measured for previous data queries;
Type of the current data query;
Current resources of the processing unit.

20. A method of inserting data in a data structure comprising a plurality of databases, at least a first database of the plurality of databases having a different structure than a second database of the plurality of databases, the method comprising, by at least a processing unit:
selecting a subset of data to be inserted in each database, based on at least an insertion criterion,
inserting each subset of data in each database,
extracting keywords from the data of each subset of data,
updating a routing table, said update comprising associating in said routing table the keywords extracted from each subset of data to the database in which said subset of data was inserted, said routing table being used at least for querying the data in the data structure.

21. The method of claim 20, comprising updating the routing table when a new database is inserted in the data structure.

22. The method of claim 20, comprising updating the routing table when new data are inserted in the data structure.

23. The method of claim 20, comprising:
inserting data that are expected to be directly queried by a user in a database of the data structure which is queriable by a plurality of keys, and/or
inserting data that are not expected to be directly queried by the user in a database of the data structure which is queriable only by a single key.

24. A non-transitory storage device readable by a processing unit, tangibly embodying a program of instructions executable by a processing unit to perform a method of querying data in a data structure comprising a plurality of databases, at least a first database of the plurality of databases having a different structure than a second database of the plurality of databases, the method comprising:
providing a routing table associating to each keyword of a list of keywords at least one database of the data structure,
for a data query:
constructing at least a sub-query based on the data query,
determining, based on at least said routing table, at least a keyword present in the sub-query and at least one database of the data structure associated to said at least keyword,
sending said sub-query to said at least one database which is associated to the keyword present in said sub-query in the routing table,
extracting data from said at least one database based on said sub-query, and
outputting a result to the data query based at least on the extracted data.

25. A system comprising:
a data structure comprising a plurality of databases, at least a first database of the plurality of databases having a different structure than a second database of the plurality of databases,
at least a routing table associating to each keyword of a list of keywords at least one database of the data structure, and
at least a processing unit configured to, for a data query:
construct at least a sub-query based on the data query,
determine, based on at least said routing table, at least a keyword present in the sub-query and at least one database of the data structure associated to said at least keyword,
send said sub-query to said at least one database which is associated to the keyword present in said sub-query in the routing table,
extract data from said at least one database based on said sub-query, and
output a result to the data query based at least on the extracted data.

26. The system of claim 25, wherein the processing unit is configured to:
construct a first sub-query based on the data query,
send the first sub-query to at least a database of the data structure which is associated in the routing table to a first keyword present in the first sub-query,
construct a second sub-query based on the data query,
send the second sub-query to at least a database of the data structure which is associated in the routing table to a second keyword present in the second sub-query, and
output a result to the data query based at least on the results of the first and second sub-queries.

27. The system of claim 25, wherein the processing unit is configured to:
construct a first sub-query based on the data query,
send the first sub-query to at least a database of the data structure which is associated in the routing table to a first keyword of the first sub-query, for providing first results,
construct a second sub-query based on the data query and on the first results,
send the second sub-query to at least a database of the data structure which is associated in the routing table to a second keyword present in the second sub-query, and
output a result to the data query based at least on the results of the second sub-query.

28. The system of claim 25, wherein the processing unit is configured to construct a first sub-query based on the data query and a second sub-query based on the data query, wherein if a first keyword of the first sub-query and a second keyword of the second sub-query are associated to the same database in the routing table, the processing unit is configured to merge the first sub-query and the second sub-query into a consolidated sub-query.

29. The system of claim 25, wherein the plurality of databases comprises at least one of a key value store database, a search engine database, and a graph database.

30. The system of claim 25, wherein the data structure further comprises a file system.

31. The system of claim 25, wherein the processing unit is configured to aggregate the data extracted from each database, to output the result to the data query based on said aggregation.

32. The system of claim 25, wherein the processing unit is configured to express the sub-query in a programming language which is independent from a programming language understandable by each database.

33. The system of claim 25, further comprising an adapter which is configured to convert at least part of the sub-query in a programming language which is understandable by each database to which the sub-query is sent.

34. The system of claim 25, wherein the processing unit is configured to update the routing table when new data are inserted in the data structure, said update comprising associating at least a keyword present in the new data to at least a database of the data structure.

35. The system of claim 25, wherein the processing unit is configured to update the routing table when a new database is inserted into the data structure, said update comprising associating at least a keyword to said new database in the routing table.

36. The system of claim 25, wherein when a new database is inserted into the data structure, the system is configured to receive an adapter which converts the sub-query which is to be sent to said new database in a programming language which is understandable by said new database.

37. The system of claim 25, wherein a querying layer of the data structure which computes each sub-query to be sent to each database based on the data query remains unchanged when a new database is inserted in the data structure.

38. The system of claim 25, wherein when data are inserted into at least a database of the data structure, the processing unit is configured to:
extract at least a keyword from said data, and
associate in the routing table said keyword to the database in which said data were inserted.

39. The system of claim 25, wherein the processing unit is configured to update the association of the keywords with the database in the routing table over time.

40. The system of claim 25, wherein the processing unit is configured to:
measure a time response for a plurality of previous data queries, and
update the routing table and/or select the database to which a current sub-query is sent based at least on said time response.

41. The system of claim 25, wherein the processing unit is configured to:
measure a first time response for at least a previous sub-query comprising at least a first keyword and a second time response for at least a previous sub-query comprising at least a second keyword, and
construct at least a first sub-query and a second sub-query based on the data query, wherein the first sub-query comprises said first keyword and the second sub-query comprises said second keyword, wherein the order in which the first sub-query and the second sub-query are executed is based on a comparison between the first time response and the second time response.

42. The system of claim 25, wherein for at least a keyword associated to a plurality of databases in the routing table, the processing unit is configured to send a sub-query to each database, measure performance of each sub-query, and associate one of the databases to said keyword in the routing table based on a comparison between performance of each sub-query.

43. The system of claim 25, wherein the processing unit is configured to update the routing table and/or select the database to which a current sub-query is sent based at least on:
Current and/or past load of the databases;
Size of a current data query;
Time response measured for previous data queries;
Type of the current data query;
Current resources of the processing unit.

44. A system for inserting data in a data structure comprising a plurality of databases, at least a first database of the plurality of databases having a different structure than a second database of the plurality of databases, the system comprising at least a processing unit configured to:
select a subset of data to be inserted in each database, based on at least an insertion criterion,
insert each subset of data in each database,
extract keywords from the data of each subset of data, and
update a routing table of the data structure, said update comprising associating in said routing table the keywords extracted from each subset of data to the database in which said subset of data was inserted, said routing table being used at least for querying the data in the data structure.

45. The system of claim 44, wherein the processing unit is configured to update the routing table when a new database is inserted in the data structure.

46. The system of claim 44, wherein the processing unit is configured to update the routing table when new data are inserted in the data structure.

47. The system of claim 44, wherein the processing unit is configured to:
insert data that are expected to be directly queried by a user in a database of the data structure which is queriable by a plurality of keys, and/or
insert data that are not expected to be directly queried by the user in a database of the data structure which is queriable only by a single key.

48. A non-transitory storage device readable by a processing unit, tangibly embodying a program of instructions executable by a processing unit to perform a method of inserting data in a data structure comprising a plurality of databases, at least a first database of the plurality of databases having a different structure than a second database of the plurality of databases, the method comprising:
selecting a subset of data to be inserted in each database, based on at least an insertion criterion,
inserting each subset of data in each database,
extracting keywords from the data of each subset of data, and
updating a routing table, said update comprising associating in said routing table the keywords extracted from each subset of data to the database in which said subset of data was inserted, said routing table being used at least for querying the data in the data structure.
